(19) United States
(12) Patent Application Publication
(10) Pub. No.: US 2026/0352024 A1
(43) Pub. Date: Nov. 5, 2026

(54) MULTI-FUNCTIONAL WIRELESS CHARGING MOUSE PAD KIT AND ELECTRIC CIRCUIT SYSTEM THEREFOR

(71) Applicant: MoDa Electronic Technology (Huizhou) Co., Ltd, Huizhou (CN)

(72) Inventor: Han TONG, Huizhou (CN)

(73) Assignee: MoDa Electronic Technology (Huizhou) Co., Ltd, Huizhou (CN)

(21) Appl. No.: 19/443,054

(22) Filed: Jan. 8, 2026

(30) Foreign Application Priority Data
Apr. 30, 2025 (CN) 2025208587898

(51) Int. Cl. H02J 50/12; G06F 1/26; G06F 3/02; G06F 3/023; G06F 3/0354; G06F 3/038; G06F 3/039; H02J 50/40

(52) U.S. Cl. CPC H02J 50/12; G06F 1/266; G06F 3/0227; G06F 3/0231; G06F 3/03543; G06F 3/038; G06F 3/0395; H02J 50/402; G06F 2203/0384

(57) ABSTRACT

The invention discloses a multi-functional wireless charging mouse pad kit and an electric circuit system therefor. The kit includes a foldable mouse pad and a mouse receiver module. The mouse pad features charging areas for mobile phones, earphones, keyboards, and mice. The first three use the QI wireless charging protocol, while the charging area for mice utilizes magnetic resonance technology and is equipped with a magnetic charging cable to be compatible with various types of mice. The invention integrates multiple wireless charging functions, offers strong compatibility, allows for simultaneous charging of multiple devices, and features a foldable design for easy storage, keeping the desktop tidy.

### CROSS-REFERENCE TO RELATED APPLICATIONS

The application claims priority to Chinese patent application No. 2025208587898, filed on Apr. 30, 2025, the entire contents of which are incorporated herein by reference.

### TECHNICAL FIELD

The invention relates to the field of electronic products, in particular, to a multi-functional wireless charging mouse pad kit.

### BACKGROUND

Existing mouse pads with wireless charging capabilities or other wireless charging devices are often limited in functionality, only able to wirelessly charge either mobile phones and Bluetooth earphones, or keyboards and mice. This means that charging multiple devices requires multiple charging cables and occupies multiple charging ports. These cables and wireless chargers also contribute to a cluttered and untidy computer desktop, and the use of multiple chargers represents a waste of resources.

### SUMMARY

In view of the above, an objective of the invention is to provide a multi-functional wireless charging mouse pad kit and an electric circuit system therefor for the problems in the prior art.

In the solution of the invention, a multi-functional wireless charging mouse pad kit includes a foldable multi-functional wireless charging mouse pad and a mouse wireless charging receiver module, wherein a surface of the foldable multi-functional wireless charging mouse pad is divided into a mobile phone charging area, an earphone charging area, a keyboard charging area, and a mouse charging area; the mobile phone charging area, the earphone charging area, and the keyboard charging area utilize QI protocol wireless charging technology to be compatible with devices that have built-in QI receiving capabilities; the mouse charging area utilizes magnetic resonance wireless charging technology in conjunction with the mouse wireless charging receiver module to charge the mouse, and the mouse charging area is further provided with a magnetic charging cable to charge other wireless mice that cannot be equipped with the mouse wireless charging receiver module. One end of the magnetic charging cable may be connected to a power supply main board, and the other end cooperates with a magnetic connector on the mouse to facilitate compatibility with charging other wireless mice.

Further, the keyboard charging area is divided into three charging positions.

Further, a keyboard magnetic wireless charging receiver patch is disposed to be compatible with wireless keyboards that do not have built-in QI protocol wireless charging receiving capabilities.

Further, the foldable multi-functional wireless charging mouse pad includes a bottom casing, a circuit board coil assembly, a panel, a mouse pad, a power supply main board, a power supply main board casing bottom cover, and a power supply main board casing upper cover; the circuit board coil assembly is mounted inside the bottom casing, the panel is attached to the bottom casing, and the mouse pad is placed on the panel; the power supply main board is connected to the circuit board coil assembly, and the power supply main board is enclosed by the power supply main board casing bottom cover and the power supply main board casing upper cover.

Further, the bottom casing is made of silicone material, a coil in the circuit board coil assembly is made of a foldable multi-strand magnet wire coil, the panel is made of PU leather material, and the mouse pad is made of silicone rubber or PU leather material.

Further, the power supply main board and the circuit board coil assembly are connected with each other using an ultra-thin flexible FPC cable, and using the ultra-thin FPC connector cable provides the convenience of press-fit assembly at the folding point.

An electric circuit system for mouse pad, including:
a mobile phone charging area, an earphone charging area, a keyboard charging area, and a mouse charging area;
a power supply input module, provided with a Type-C female connector for connecting to an external power supply;
a touch switch chip, connected to the power supply input module for controlling an on/off state of a power supply;
a linear voltage regulator chip, receiving a power from the power supply input module and converting the power into a stable low voltage;
an MCU, powered by the linear voltage regulator chip, the MCU outputting an independent 12V power supply and a 5V power supply, the 12V power supply powering QI protocol wireless charging circuit board coil assemblies of the mobile phone charging area, the earphone charging area and the keyboard charging area, the 5V power supply powering the magnetic charging cable of the mouse charging area; magnetic resonance charging functions of the keyboard charging area is integrated into the power supply main board;
a current limiting chip, connected to a 5V power supply output terminal of the MCU to dynamically regulate a current of the mouse charging area;
a boost converter chip and a wireless charging transmitter chip, driving a transmitting coil of the mouse charging area to achieve magnetic resonance wireless charging;
a resonant capacitor, in conjunction with the transmitting coil to dynamically optimize an operating frequency by adjusting resonant parameters for being compatible with charging requirements of different receiver modules.

Compared with the prior art, the solution of the kit has the following advantages:

Versatile and highly integrated: The kit is provided with four charging areas of the mobile phone charging area, the earphone charging area, the keyboard charging area and the mouse charging area for charging multiple devices simultaneously, which meets diverse charging needs of users without requiring multiple charging cables and power ports, and is compatible with all wireless keyboards and mice to truly enable a wireless and clutter-free desktop; the foldable design makes it convenient for carrying, storage, and transportation, significantly reducing resource waste.

Stable charging: The charging areas for mobile phones, earphones, and keyboards utilize mature, universal QI protocol wireless charging technology, offering broad compatibility and working with all devices that have built-in QI standard wireless charging receiver capabilities; the mouse charging area utilizes magnetic resonance wireless charging technology, in combination of a dedicated wireless charging receiver module for the mouse, to ensure that charging remains uninterrupted even when the mouse is moving, stationary, or slightly lifted, and simultaneous charging for multiple mice is supported, which greatly improves charging convenience and efficiency.

Strong compatibility: The keyboard charging area is divided into three charging positions, taking into account the differences in the positions of wireless charging receiver coils of various keyboards; regardless of the brand or model of the wireless keyboard, a suitable charging position may be found, ensuring stable and effective charging. In addition, a wireless charging receiver patch that uses the QI protocol is equipped to allow wireless keyboards without built-in wireless charging receiver capabilities to also be charged wirelessly, which enables older devices to enjoy the convenience of wireless charging. The magnetic charging cable has been added to the mouse charging area to be compatible with wireless mice that cannot be equipped with the wireless charging receiver module, which also greatly increases the compatibility for charging various types of mice.

### BRIEF DESCRIPTION OF DRAWINGS

FIG. 1 is an overall diagram of the application;

FIG. 2 is a structural diagram of a foldable multi-functional wireless charging mouse pad;

FIG. 3 is a circuit diagram of the electric circuit system;

FIG. 4 is a circuit diagram of a wireless charging receiver module of a mouse;

FIG. 5 is an enlarged view of a circuit related to a TYPE-C female connector in FIG. 3.

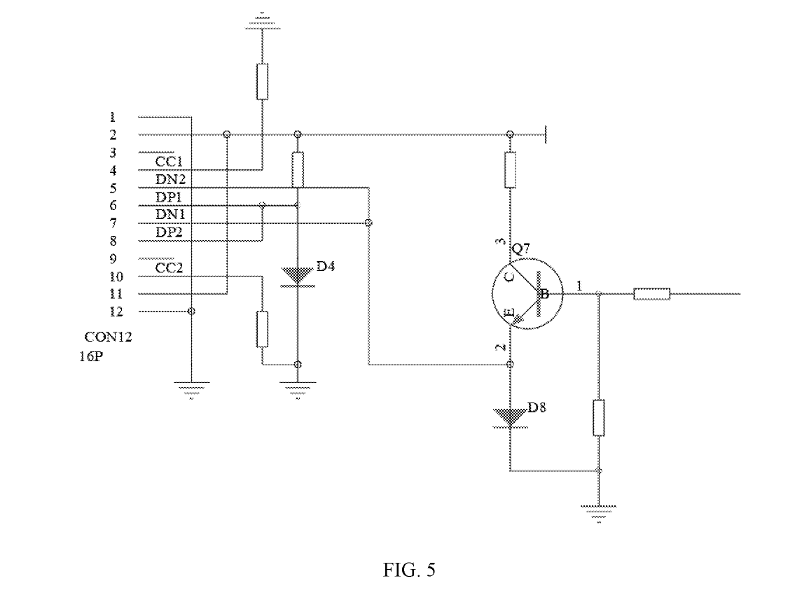

FIG. 6 is an enlarged view of a circuit related to a touch switch chip in FIG. 3.

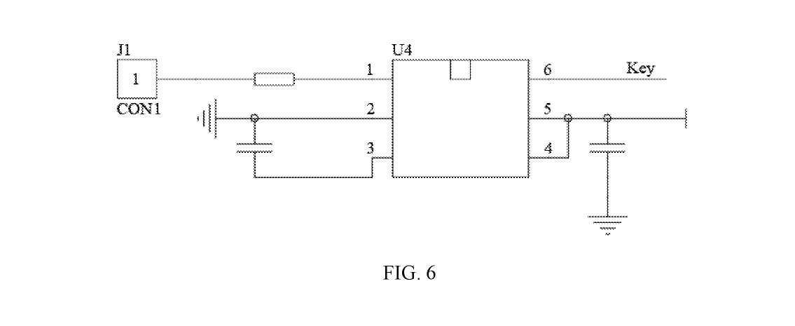

FIG. 7 is an enlarged view of a circuit related to MCU in FIG. 3.

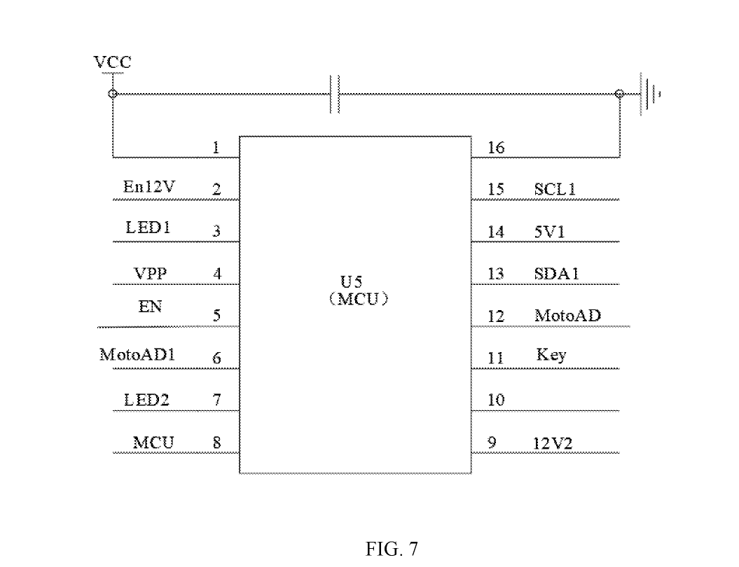

Descriptions of reference numerals: foldable multi-functional wireless charging mouse pad-100; mobile phone charging area-10a; earphone charging area-10b; keyboard charging area-10c; mouse charging area-10d; bottom casing-101; circuit board coil assembly-102; panel-103; mouse pad-104; power supply main board-105; power supply main board casing bottom cover-106; power supply main board casing upper cover-107; mouse wireless charging receiver module-200; keyboard magnetic wireless charging receiver patch-400; TYPE-C female connector-300; current limiting chip-301; boost converter chip-302; wireless charging transmitter chip-303; touch switch chip-304; MCU-305; linear voltage regulator chip-306; 12V power supply-307; transmitting coil-308; sampling resistor-309; resonant capacitor-310.

### DETAILED DESCRIPTION OF THE EMBODIMENTS

Clear and intact description will be made on technical schemes in the embodiments of the invention below in combination with drawings in the embodiments of the invention. Obviously, the described embodiments are merely a part of embodiments of the invention and are not all the embodiments. Based on the embodiments of the present invention, all the other embodiments obtained by those of ordinary skill in the art without inventive effort are within the scope of the present invention.

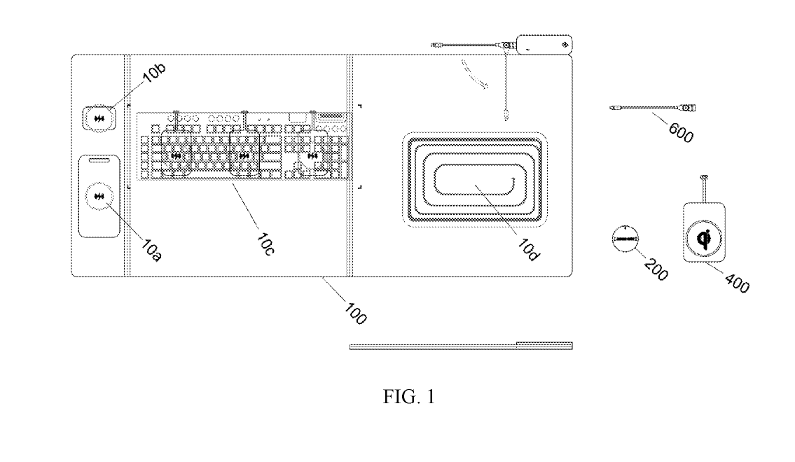

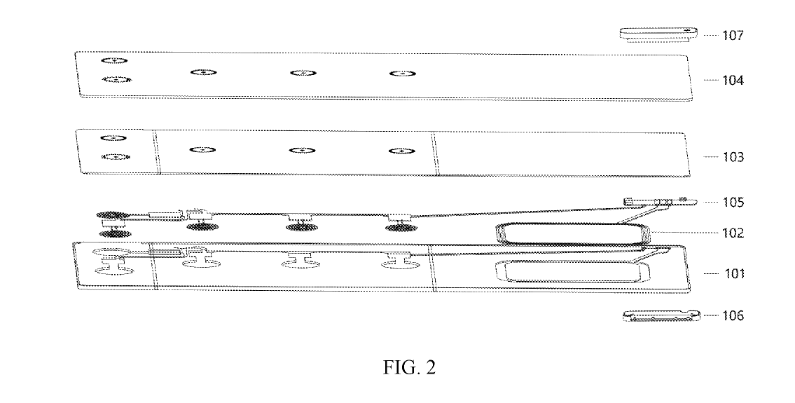

As shown in FIGS. 1 and 2, a magnetic charging cable 600 is added to a mouse charging area to be compatible with a wireless mouse charging kit that do not have a built-in wireless charging receiver module. A foldable multi-functional wireless charging mouse pad 100 is provided, with four designated charging areas of a mobile phone charging area 10a, an earphone charging area 10b, a keyboard charging area 10c and a mouse charging area 10d. Diverse charging needs for users are being met. The mobile phone charging area 10a, the earphone charging area 10b, and the keyboard charging area 10c all utilize mature Qi protocol wireless charging technology. The technology boasts broad compatibility, working with virtually all devices on the market that have built-in wireless charging capabilities. Whether the device is a cell phone, an earphone, or a keyboard, simply placing in the corresponding area may quickly start charging and makes a cluttered desktop become a history.

The mouse charging area 10d utilizes magnetic resonance wireless charging technology. By simply equipping the mouse with the dedicated wireless charging receiver module 200, the mouse may be freely charged in the mouse charging area 10d. The mouse will not disconnect from charging, whether being is in motion, stationary, or even in a slight lifting motion during use. In addition, the mouse charging area 10d supports charging multiple mice simultaneously, greatly improving the convenience and efficiency of charging for users who own multiple mouse devices.

To further improve the compatibility of the mouse charging area 10d, a magnetic charging cable 600 has been added to the mouse charging area 10d. The magnetic charging cable 600 draws power from a power supply main board 105 to be compatible with other mouse models that cannot install the wireless charging receiver module 200. A USB plug end of the magnetic charging cable is designed with a 90-degree rotatable structure. When in use, the magnetic cable is rotated to the mouse charging area 10d; when not in use, the magnetic cable is rotated to be parallel with the foldable multi-functional wireless charging mouse pad 100, thus maintaining the clean and organized desktop design concept of the kit.

To further improve the compatibility of keyboard charging, the keyboard charging area 10c is divided into three charging positions. The design fully considers the differences in the placement of wireless charging receiver coils in different keyboards. Regardless of the brand or model of wireless keyboard the user is using, a suitable charging position may be found in the keyboard charging area 10c, ensuring stable and effective charging.

Furthermore, the kit is further equipped with a magnetic wireless charging receiver patch (400) with magnetic positioning functionality, compatible with the QI protocol. For wireless keyboards that do not have built-in wireless charging capabilities, users simply need to attach the patch to the designated position on a bottom of the keyboard and connect the same to the charging interface of the keyboard via contact points or wires. This will enable wireless charging functionality for keyboards, allowing older devices to also enjoy the convenience of wireless charging.

Specifically, the foldable multi-functional wireless charging mouse pad 100 consists of several components, including the bottom casing 101, a circuit board coil assembly 102, a panel 103, a mouse pad 104, a power supply main board 105, a power supply main board casing bottom cover 106, and a power supply main board casing top cover 107. The circuit board coil assembly 102 is mounted inside the bottom casing 101, the panel 103 is attached to the bottom casing 101, and the mouse pad 104 is placed on the panel 103; the power supply main board 105 is connected to the circuit board coil assembly 102 using a flexible printed circuit (FPC) cable, and the power supply main board casing bottom cover 106 and the power supply main board casing top cover 107 enclose the power supply main board 105. The circuit board coil assembly 102, as a core component, is mounted inside the bottom casing 101. The circuit board coil assembly 102 includes multiple coils corresponding to various areas. A transmitting coil 308 corresponding to the mouse charging area 10d is a large coil, while a receiving coil of the mouse wireless charging receiver module 200 is a small coil, so that the small receiving coil is allowed to be charged within a magnetic field range of the large transmitting coil, and an area of the large transmitting coil may be 1-50 times that of the small receiving coil.

The bottom casing 101 is made of soft and durable silicone material, which not only provides excellent anti-slip properties for allowing the bottom casing to be placed securely on the desktop and preventing the mouse pad 104 from shifting due to mouse movements, but also offers a certain degree of cushioning to protect the internal components from external impacts. The coils in the circuit board coil assembly 102 are made of foldable multi-strand magnetic wire coils or PCB coils. The power supply main board 105 and the circuit board coil assembly 102 are connected with each other using an ultra-thin flexible FPC cable, and using the ultra-thin FPC connector cable makes it feasible to assemble and connect components at the folding points.

The panel 103 is made of PU leather material, which has a delicate texture and a smooth surface, enhancing the aesthetics of the product and facilitating cleaning and maintaining. The mouse pad 104 may be made of either silicone rubber or PU leather, depending on the user preference. Whether the user prefers the soft touch of silicone rubber or the premium feel of PU leather, both materials provide a comfortable user experience. Meanwhile, the mouse pad 104 is placed directly on the panel 103. This design allows the mouse pad 104 to be easily separated from others. When the mouse pad 104 becomes dirty after a period of use, the user may easily remove the mouse pad for cleaning or replacement, thus maintaining a clean and tidy desktop.

Thanks to the materials used, the foldable multi-functional wireless charging mouse pad 100 may be easily folded and stored when not in use, saving significant space and making it convenient for users to carry and transport. Whether traveling for business, studying away from home, or using devices at home, the users may enjoy the convenience of wireless charging anytime, anywhere.

The mouse pad 104 is printed clearly with position markers for each charging area and has a magnetic positioning function to allow even first-time users to quickly find the correct charging position, which is simple and easy to use.

With reference to FIGS. 1-3 an electric circuit system for the foldable multi-functional wireless charging mouse pad 100 is described as below. The power supply is input through a TYPE-C female connector 300. A touch switch chip 304 controls the power on/off function, allowing the user to activate the charging function via touch. A linear voltage regulator chip 306 then regulates and converts the input power supply to a stable low voltage, providing operating power supply to an MCU 305 and ensuring the stability of the control logic. Pin 9 of the MCU 305 outputs an independent 12V power supply 307, which supplies power to the QI protocol wireless charging circuit board coil assemblies in the mobile phone charging area 10a, the earphone charging area 10b, and the keyboard charging area 10c.

Pin 5 of the MCU305 outputs a 5V power supply, which is then dynamically regulated for the current by a current limiting chip 301 to power the mouse charging area 10d. When metal foreign objects are detected or the coil is overloaded, the current limiting chip 301 automatically limits current fluctuations to prevent circuit damage. A circuit for the mouse charging area 10d consists of a boost converter chip 302 (using the XKT-203 chip), a wireless charging transmitter chip 303 (using the XKT-001 chip), and the above transmitting coil 308. By adjusting inductance parameters of a sampling resistor 309, a resonant capacitor 310 and the transmitting coil 308 connected of pins 4 and 5 of the wireless charging transmitter chip 303, the magnetic resonance operating frequency may be dynamically optimized to be compatible with the resonant requirements of different mouse receiver modules. The transmitting coil 308 is wound with multi-strand magnetic wires or the PCB coil, with an area designed to be 1-50 times that of the receiving coil to ensure continuous charging when the mouse is in use during movement.

The circuit board coil assembly 102 has a built-in overvoltage and overcurrent protection circuit, which works in conjunction with the MCU 305 to provide real-time monitoring and feedback on a charging status via LED indicator lights. The layout of three independent coils in the keyboard charging area 10c, in combination of Qi protocol power distribution, supports the adaptation of wireless charging positions for multiple keyboard brands, ensuring strong compatibility.

The invention features efficient power management, using the MCU 305 to control multiple outputs in a time-sharing manner, thereby reducing power consumption and improving charging efficiency. The magnetic resonance circuit supports the design of adjustable parameters, allowing for dynamic adjustment of the operating frequency to adapt to charging requirements in different scenarios. The invention has multiple protection mechanisms, with current limiting chip 301 and MCU 305 working together to ensure system safety and stability.

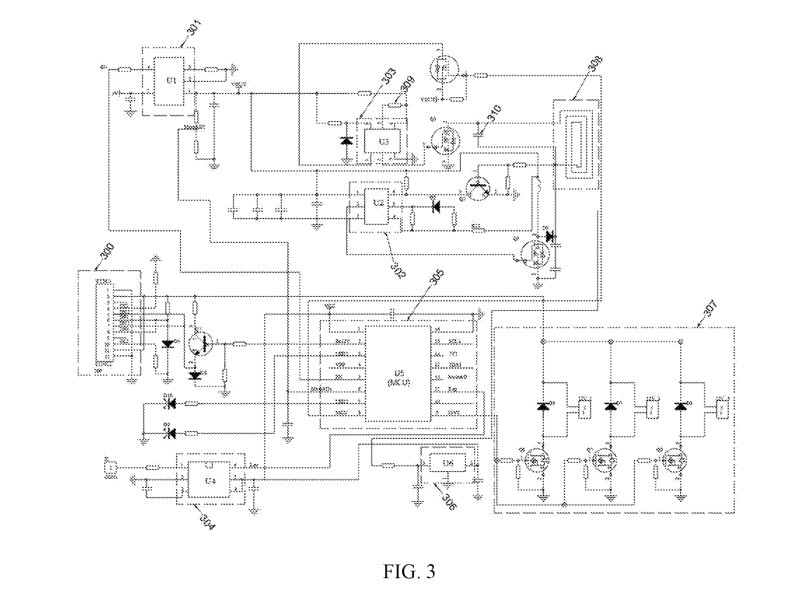

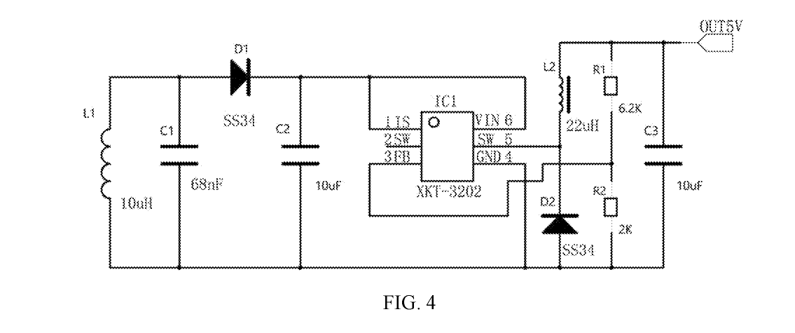

With reference to FIG. 4, a circuit diagram of the mouse wireless charging receiver module 200 is shown below, which uses the XKT3202 wireless charging receiver chip (which may be replaced with the XKT-3168). The receiving circuit is a constant-voltage output circuit, and a charging voltage for a mouse battery in this patent is 5V. The output voltage may further be adjusted via R1 in FIG. 4, and increasing the resistance will increase the voltage. Values of the receiving coil L1 and the resonant capacitor C1 are adjusted according to the transmitting coil 308, the resonant capacitor 310, and the sampling resistor 309 shown in FIG. 3, in order to adapt to the charging voltage requirements of different batteries. The receiver circuit is simple in design, low in cost, and suitable for a wide range of applications.

Although the embodiments of the present invention have been shown and described, it can be understood that a person skilled in the art can make various changes, modifications, substitutions and variations to the embodiments without departing from the principle and spirit of the present invention; and the scope of the present invention is defined by the attached claims and equivalents thereof.

What is claimed is:

1. A multi-functional wireless charging mouse pad kit, comprising a foldable multi-functional wireless charging mouse pad (100) and a mouse wireless charging receiver module (200), wherein a surface of the foldable multi-functional wireless charging mouse pad (100) is divided into a mobile phone charging area (10a), an earphone charging area (10b), a keyboard charging area (10c), and a mouse charging area (10d); the mobile phone charging area (10a), the earphone charging area (10b), and the keyboard charging area (10c) utilize QI protocol wireless charging technology to be compatible with devices that have built-in QI receiving capabilities; the mouse charging area (10d) utilizes magnetic resonance wireless charging technology in conjunction with the mouse wireless charging receiver module (200) to charge the mouse, and the mouse charging area (10d) is further provided with a magnetic charging cable (600) to charge other wireless mice that cannot be equipped with the mouse wireless charging receiver module (200).

2. The multi-functional wireless charging mouse pad kit according to claim 1, wherein the keyboard charging area (10c) is divided into three charging positions, each corresponding to charging ports of different keyboards.

3. The multi-functional wireless charging mouse pad kit according to claim 1, wherein a keyboard magnetic wireless charging receiver patch (400) is disposed to be compatible with wireless keyboards that do not have built-in QI protocol wireless charging receiving capabilities.

4. The multi-functional wireless charging mouse pad kit according to claim 1, wherein the foldable multi-functional wireless charging mouse pad (100) comprises a bottom casing (101), a circuit board coil assembly (102), a panel (103), a mouse pad (104), a power supply main board (105), a power supply main board casing bottom cover (106), and a power supply main board casing upper cover (107); the circuit board coil assembly (102) is mounted inside the bottom casing (101), the panel (103) is attached to the bottom casing (101), and the mouse pad (104) is placed on the panel (103); the power supply main board (105) is connected to the circuit board coil assembly (102), and the power supply main board (105) is enclosed by the power supply main board casing bottom cover (106) and the power supply main board casing upper cover (107).

5. The multi-functional wireless charging mouse pad kit according to claim 4, wherein the bottom casing (101) is made of silicone material, a coil in the circuit board coil assembly (102) is made of a foldable multi-strand magnet wire coil, the panel (103) is made of PU leather material, and the mouse pad (104) is made of silicone rubber or PU leather material.

6. An electric circuit system for mouse pad, comprising:
a mobile phone charging area (10a), an earphone charging area (10b), a keyboard charging area (10c), and a mouse charging area (10d);
a power supply input module, provided with a Type-C female connector (300) for connecting to an external power supply;
a touch switch chip (304), connected to the power supply input module for controlling an on/off state of a power supply;
a linear voltage regulator chip (306), receiving a power from the power supply input module and converting the power into a stable low voltage;
an MCU (305), powered by the linear voltage regulator chip (306), the MCU (305) outputting an independent 12V power supply (307) and a 5V power supply, the 12V power supply (307) powering QI protocol wireless charging circuit board coil assemblies of the mobile phone charging area (10a), the earphone charging area (10b) and the keyboard charging area (10c), the 5V power supply powering the magnetic charging cable (600) of the mouse charging area (10d);
a current limiting chip (301), connected to a 5V power supply output terminal of the MCU (305) to dynamically regulate a current of the mouse charging area (10d);
a boost converter chip (302) and a wireless charging transmitter chip (303), driving a transmitting coil (308) of the mouse charging area (10d) to achieve magnetic resonance wireless charging;
a resonant capacitor (310), in conjunction with the transmitting coil (308) to dynamically optimize an operating frequency by adjusting resonant parameters for being compatible with charging requirements of different receiver modules.
